(19) United States
(12) Patent Application Publication
(10) Pub. No.: US 2010/0188542 A1
(43) Pub. Date: Jul. 29, 2010

(54) IMAGING DEVICE AND IMAGE SENSOR CHIP

(75) Inventors: Toshitaka MIZUGUCHI, Tokyo (JP); Katsuyoshi Yamamoto, Tokyo (JP)

Correspondence Address: ARENT FOX LLP, 1050 CONNECTICUT AVENUE, N.W., SUITE 400, WASHINGTON, DC, 20036, US

(73) Assignee: FUJITSU MICROELECTRONICS LIMITED, Yokohama-shi (JP)

(21) Appl. No.: 12/692,037

(22) Filed: Jan. 22, 2010

(30) Foreign Application Priority Data
Jan. 29, 2009 (JP) 2009-18069

(51) Int. Cl. H04N 5/335

(52) U.S. Cl. 348/302; 348/E05.091

(57) ABSTRACT

An imaging device includes a pixel array that includes a plurality of pixels, a data read circuit that sequentially reads the data of a given line from the pixel array, a plurality of column analog-digital converters that perform analog-digital conversion on the data from the data read circuit, and a control signal generating circuit that generates a control signal to control the analog-digital conversion.

### CROSS-REFERENCE TO RELATED APPLICATIONS

This application claims the benefit of priority from Japanese Patent Application No. 2009-18069 filed on Jan. 29, 2009, the entire contents of which are incorporated herein by reference.

### BACKGROUND

1. Field

Embodiments discussed herein relate to an imaging device.

2. Description of Related Art

The number of pixels and speed increases in the imaging device used in a digital camera and a digital video camera. Desirably, a column Analog-Digital Converter (ADC) converts analog signals detected in a pixel array including plural pixels into digital signals at high speed.

For example, related techniques are discussed in Japanese Laid-open Patent Publication Nos. 2004-222286, 2005-347932, and 2006-217245.

### SUMMARY

According to one aspect of the embodiments, an imaging device includes a pixel array that includes a plurality of pixels, a data read circuit that sequentially reads the data of a given line from the pixel array, a plurality of column analog-digital converters that perform analog-digital conversion on the data from the data read circuit, and a control signal generating circuit that generates a control signal to control the analog-digital conversion.

Additional advantages and novel features of the various embodiments will be set forth in part in the description that follows, and in part will become more apparent to those skilled in the art upon examination of the following or upon learning by practice of the various embodiments.

### BRIEF DESCRIPTION OF THE DRAWINGS

FIG. 1 illustrates an exemplary imaging device;

FIG. 2 illustrates an exemplary operation timing diagram;

FIG. 3 illustrates an exemplary imaging element;

FIG. 4 illustrates an exemplary operation timing diagram;

FIG. 5 illustrates an exemplary imaging device;

FIG. 6 illustrates an exemplary image sensor chip;

FIG. 7 illustrates an exemplary image sensor chip;

FIG. 8 illustrates an exemplary operation timing diagram;

FIG. 9 illustrates an exemplary an image sensor chip; and

FIG. 10 illustrates an exemplary operation timing diagram.

### DESCRIPTION OF EMBODIMENTS

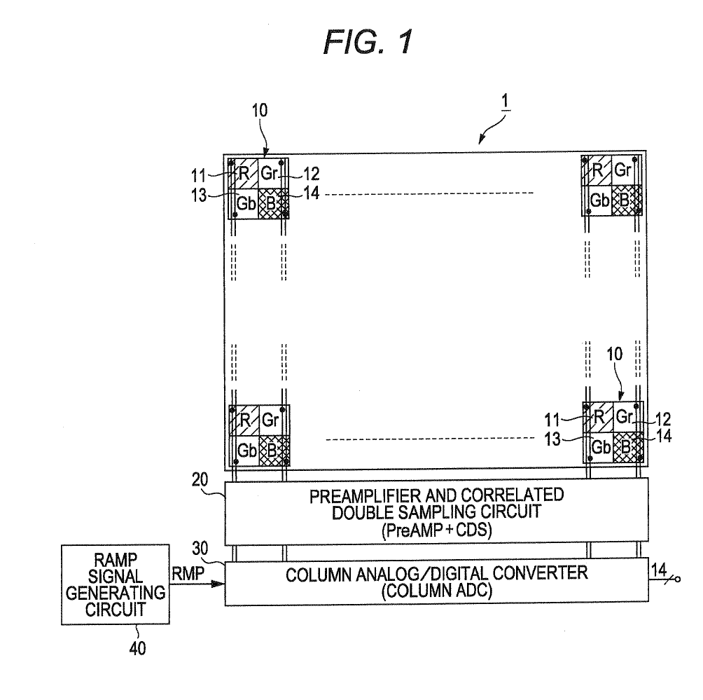

FIG. 1 illustrates an exemplary imaging device. A reference numeral 1 designates a pixel array, a reference numeral 10 designates a pixel, and reference numerals 11 to 14 designate sub-pixels (pixel). A reference numeral 20 designates a preamplifier (Pre AMP) and a Correlated Double Sampling (CDS) circuit, the reference numeral 30 designates a column Analog-Digital Converter (column ADC), and a reference numeral 40 designates a ramp signal generating circuit.

The pixel 10 may include, for example, the red sub-pixel 11, the green sub-pixels 12 and 13, and the blue sub-pixel 14. The pixel 10 may include a two-by-two matrix of sub-pixels.

The column ADC 30 converts analog data of pixels in a column direction, such as analog data of pixels in one line, which is supplied from the preamplifier and correlated double sampling circuit 20, into 14-bit data based on a ramp signal RMP from the ramp signal generating circuit 40.

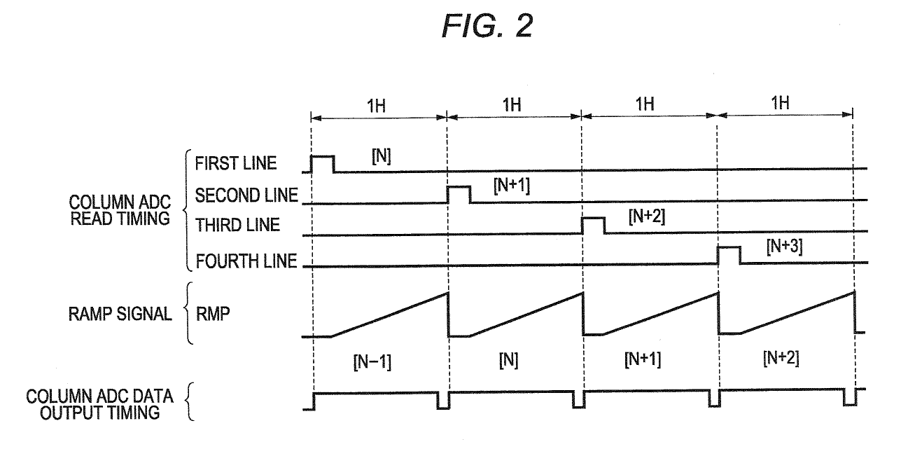

FIG. 2 illustrates an exemplary operation timing diagram. The operation timing diagram of FIG. 2 may refer to the timing of the imaging element of FIG. 1. The column ADC 30 reads the analog data at an initial timing of one horizontal time 1H every column line, and performs analog-digital conversion based on the ramp signal RMP. The column ADC 30 supplies the digital data in final timing of one horizontal time 1H.

In the imaging device illustrated in FIG. 1, the preamplifier and correlated double sampling circuit 20 reads signals from the pixel array 1, the signals are supplied to the column ADC 30, and the analog-digital conversion is performed based on the ramp signal RMP (column ADC method).

In the imaging device, one column line and two analog-digital conversion blocks may be coupled by a switching element.

In the active pixel sensor array, the red and blue pixels may be processed by one of the analog-digital conversion blocks. In the active element sensor array, the green pixel may be processed by the other analog-digital conversion block. The analog-digital conversion blocks may include sampling processing, amplifying processing, or conversion processing.

The outputs from one pixel string may be fed into at least two ADCs and the two ADCs may perform in parallel.

The conversion speed of the column ADC may be enhanced for the increased number of pixels and the speed enhancement in the imaging device, and a high resolution and a high frame rate of the output data may be obtained.

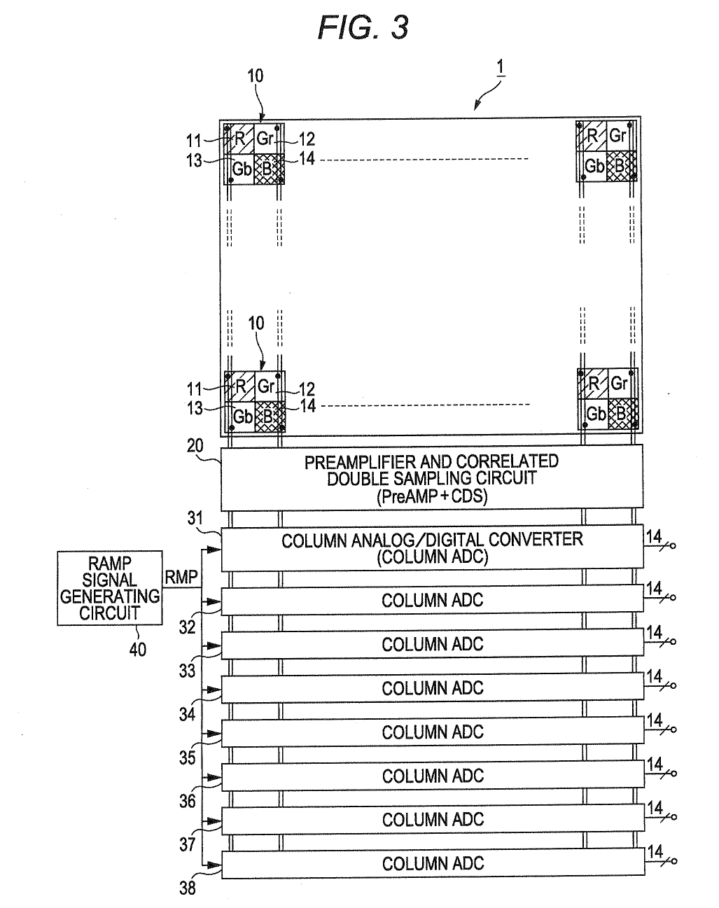

FIG. 3 illustrates an exemplary imaging element. In FIG. 3, a reference numeral 1 designates a pixel array, a reference numeral 10 designates a pixel, and reference numerals 11 to 14 designate sub-pixels, for example, a pixel. A reference numeral 20 designates a preamplifier (Pre AMP) and Correlated Double Sampling (CDS) circuit, reference numerals 31 to 38 designate column Analog-Digital Converters (column ADCs), and a reference numeral 40 designates a ramp signal generating circuit.

The pixel 10 may include, for example, the red sub-pixel 11, the green sub-pixels 12 and 13, and the blue sub-pixel 14. The pixel 10 may include the two-by-two matrix of sub-pixels, and the green sub-pixels 12 and 13 may be provided in diagonal positions of the two-by-two configuration.

As illustrated in FIG. 3, the preamplifier and correlated double sampling circuit (Pre AMP+CDS) 20 and the eight column ADCs 31 to 38 are disposed on one side of the pixel array 1 in which the pixel, for example, the sub-pixels, are disposed in a matrix shape.

The column ADC 30 converts the analog data of pixels in a column direction, such as the analog data of pixels in one line, into digital data, which is supplied from the preamplifier and correlated double sampling circuit 20, into 14-bit data based on the ramp signal RMP from the ramp signal generating circuit 40.

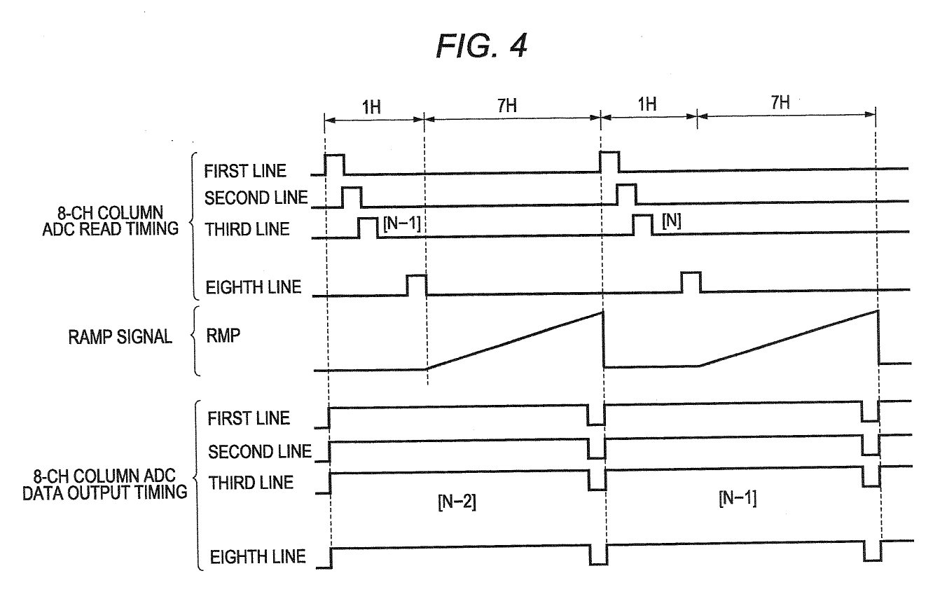

FIG. 4 illustrates an exemplary operation timing diagram. The operation timing diagram of FIG. 4 may represent the timing of the imaging element of FIG. 3. For example, in the imaging device of FIG. 3, the analog data from the eight column lines may be analog-digital converted as a unit.

In the initial horizontal time 1H, the eight column lines, for example, the analog data of first to eighth column lines, are read by the eight corresponding column ADCs 31 to 38.

The analog data of the first column line is read and retained by the column ADC 31 through the preamplifier and correlated double sampling circuit 20. The analog data of the second column line is read and retained by the column ADC 32. The analog data of the seventh column line is read and retained by the column ADC 37. The analog data of the eighth column line is read and retained by the column ADC 38.

In the horizontal time 1H, the pieces of analog data of first to eighth column lines are read and retained by the column ADCs 31 to 38. In the horizontal time 1H, the analog data of eight column lines are read by the eight column ADCs 31 to 38.

In the seven remaining horizontal times 7H, the analog-digital conversion is performed on the retained analog data based on the common ramp signal RMP. The analog-digital conversion may contemporaneously be performed on the analog data. The analog-digital converted data are output based on the ramp signal RMP supplied every eight horizontal times.

The analog data of the ninth column line is read and retained by the column ADCs 31, and similar processing is repeated.

In the embodiment, although the analog-digital conversion is performed on the analog data of the eight column lines in the eight horizontal times, the column ADCs 31 to 38 perform the analog-digital conversion in seven horizontal times.

The high-speed analog-digital conversion may be performed with a low-cost ADC, for example. The noise and the power consumption may be reduced.

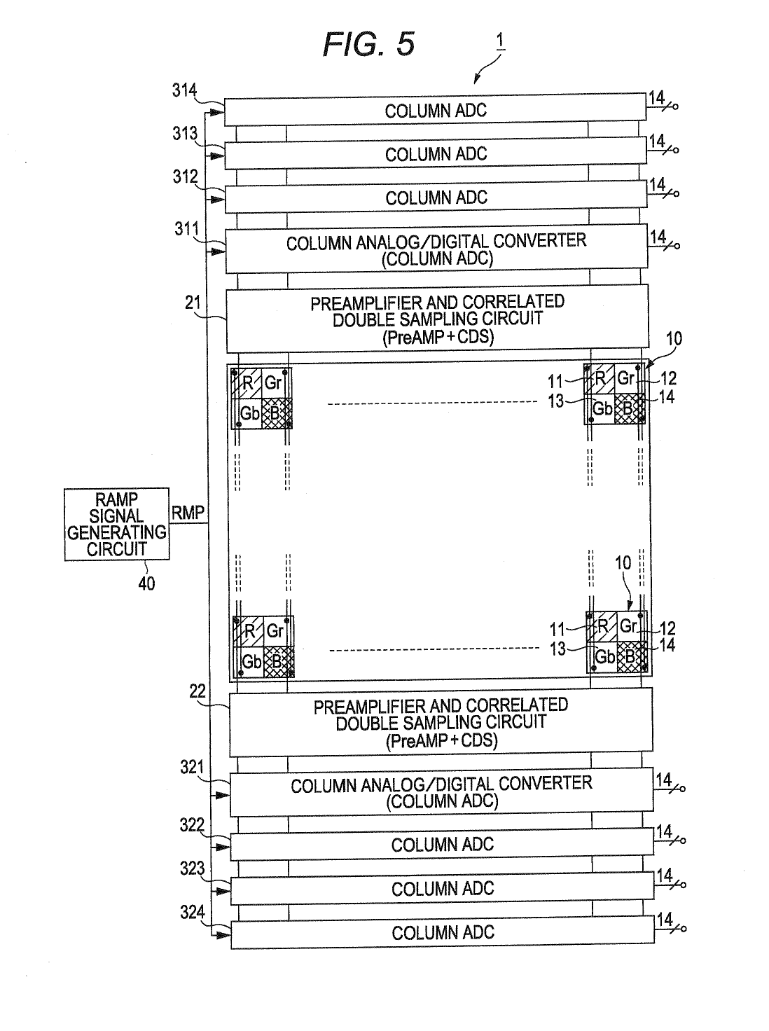

FIG. 5 illustrates an exemplary imaging device. In the imaging device of FIG. 5, for example, eight column ADCs include a first group of column ADCs 311 to 314 that are provided on an upper side of the pixel array 1 and a second group of column ADCs 321 to 324 that are provided on a lower side of the pixel array 1.

A first preamplifier and correlated double sampling circuit (Pre AMP+CDS) 21 may be provided between the pixel array 1 and the upper-side first group of column ADCs. A second preamplifier and correlated double sampling circuit 22 may be provided between the pixel array 1 and the lower-side second group of column ADCs.

The pixel 10 may include, for example, the red sub-pixel 11, the green sub-pixels 12 and 13, and the blue sub-pixel 14. The pixel 10 may include the two-by-two matrix of sub-pixels, and the green sub-pixels 12 and 13 may be provided at the diagonal positions of the two-by-two configuration.

For example, the column ADCs 311 to 314 provided on the upper side of the pixel array 1 may perform the analog-digital conversion of the data detected by the red sub-pixels 11 and green sub-pixels 12, which are located in the odd-numbered lines.

For example, the column ADCs 321 to 324 provided on the lower side of the pixel array 1 may perform the analog-digital conversion of the data detected by the green sub-pixel 13 and blue sub-pixel 14, which are located in the even-numbered lines.

In the pixel array 1, the analog-digital converted red and green data may be output from the column ADCs 311 to 314. The analog-digital converted green and blue data may be output from the column ADCs 321 to 324.

The preamplifiers and correlated double sampling circuits 21 and 22 provided on the upper and lower sides of the pixel array 1 contemporaneously read the data corresponding to the column ADCs 311 to 314 and 321 to 324 provided on the upper and lower sides of the pixel array 1.

The ramp signal generating circuit 40 supplies a common ramp signal RMP every eight horizontal time period to the column ADCs 311 to 314 and 321 to 324 provided on the upper and lower sides of the pixel array 1.

In the embodiment, eight column ADCs are provided, and processing is performed in the eight horizontal time periods as a unit. The number of column ADCs and the number of horizontal times may arbitrarily be changed. The pixel 10 may include the two-by-two matrix of four sub-pixels like the previous embodiment, or the pixel 10 may include sub-pixels having another configuration.

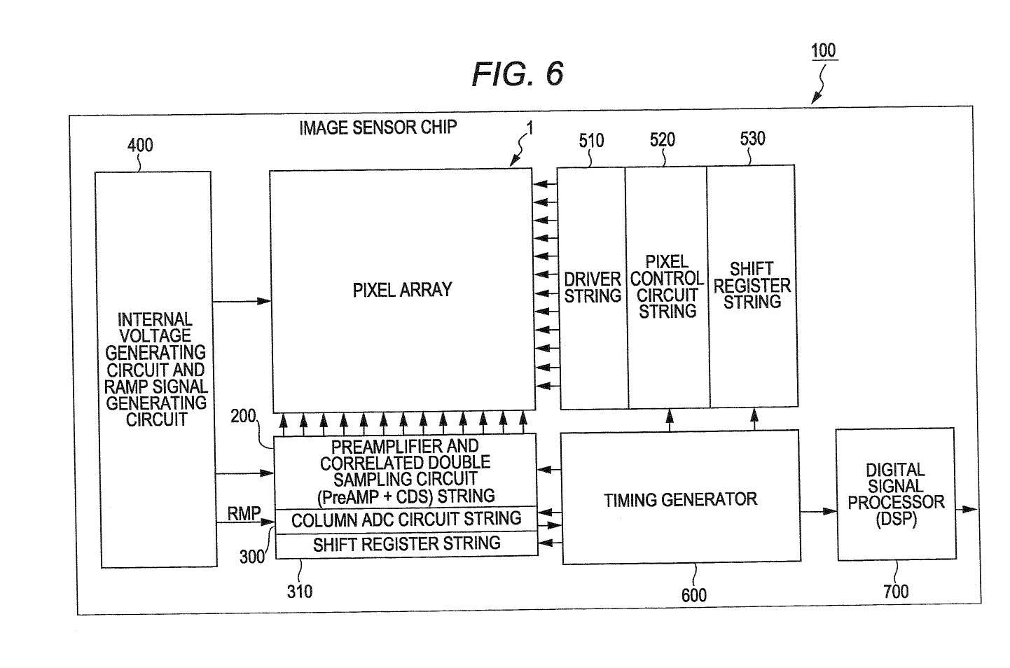

FIG. 6 illustrates an exemplary image sensor chip. The image sensor chip of FIG. 6 may include an imaging device.

An image sensor chip 100 includes the pixel array 1, an internal-voltage generating circuit and ramp signal generating circuit 400, a preamplifier and correlated double sampling circuit (Pre AMP+CDS) 200, a column ADC circuit string 300, and a shift register string 310.

The image sensor chip 100 may also include a driver string 510, a pixel control circuit string 520, a shift register string 530, a timing generator 600, and a digital signal processor (DSP) 700. The driver string 510, the pixel control circuit string 520, and the shift register string 530 may include a driver circuit.

The internal-voltage generating circuit and ramp signal generating circuit 400 generates an internal voltage such as a reset voltage VR to be supplied to the imaging element, for example, a circuit 110 corresponding to the sub-pixel 11. The internal-voltage generating circuit and ramp signal generating circuit 400 also generates the ramp signal RMP.

The pixel read circuit string 200 reads the data in the column direction of the pixel array 1, which is selected by the driver string 510 (for example, the data of the sub-pixel of every column line), and the pixel read circuit string 200 supplies the data to the column ADC circuit string 300. The pixel read circuit string 200 and the column ADC circuit string 300 may correspond to the preamplifier and correlated double sampling circuit 20 and eight column ADCs 31 to 38 of FIG. 3.

The shift register string 310 shifts and supplies the analog-digital converted data by the column ADC circuit string 300.

For example, the driver string 510 may select all of the lines of the pixel array 1 in one horizontal time 1H in accordance with the outputs of the shift register string 530 and pixel control circuit string 520.

The image sensor chip 100 includes the timing generator 600 that supplies a timing signal to the circuit block, and the digital signal processor 700 that controls the entire image sensor chip 100.

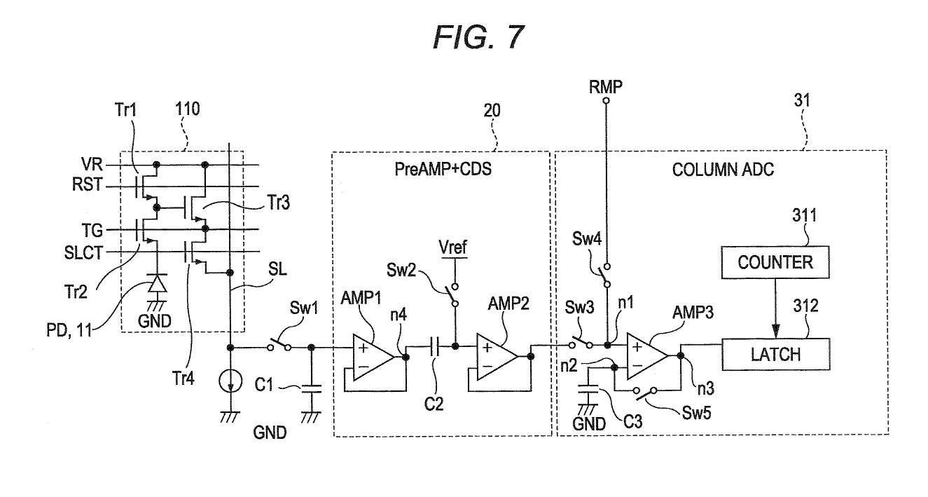

FIG. 7 illustrates an exemplary image sensor chip. The circuit of FIG. 7 may be a main part of the image sensor chip of FIG. 6. The imaging element, for example, the circuit 110 corresponding to the sub-pixel 11, includes four nMOS transistors Tr1 to Tr4 and a photodiode PD. The photodiode PD detects light incident through a color filter (for example, a red filter).

A reset signal RST is supplied to a gate of the transistor Tr1. A trigger signal TG is supplied to a gate of the transistor Tr2. A selection signal SLCT is supplied to a gate of the transistor Tr4. A gate of the transistor Tr3 is coupled to a common connection node of the transistors Tr1 and Tr2.

The preamplifier and correlated double sampling circuit 20 includes two differential amplifiers AMP1 and AMP2, a capacitor C2, and a switch Sw2. The preamplifier and correlated double sampling circuit 20 receives the analog signal from the imaging element circuit 110 through a switch Sw1. A capacitor C1, having one end thereof grounded, is provided in the input of the preamplifier and correlated double sampling circuit 20.

The column ADC, for example, the column ADC31, may include a counter 311, a latch 312, a differential amplifier AMP3, a capacitor C3, and three switches Sw3 to Sw5.

The plural imaging element circuits 110 included in the selected line in the pixel array 1 supply the signals detected by the photodiodes PD to the preamplifier and correlated double sampling circuit 20 through the corresponding read signal line SL and the switch Sw1.

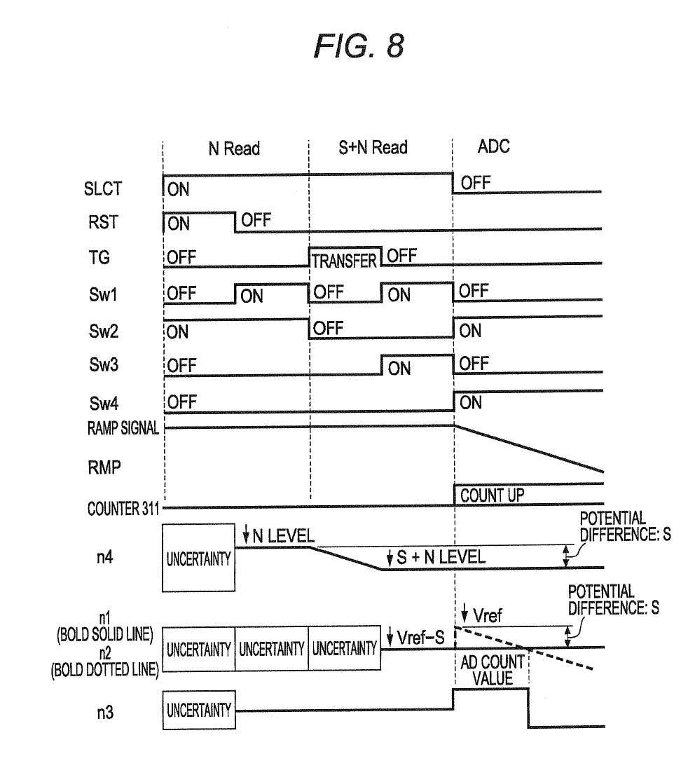

As illustrated in FIG. 8, for example, the ramp signal RMP is declined with a given gradient according to the analog-digital conversion of the column ADC 31. The ramp signal RMP is supplied to a node n1 through the switch Sw4. The latch 312 latches the output of the counter 311 according to the output of the differential amplifier AMP3, and retains the latched counter value as a digital value of the analog-digital conversion result. For example, the retained signal may be output every eight lines.

The signals SLCT, RST, and TG supplied to the imaging element circuit 110 may be the control signals of the sub-pixels (pixel). The signals for controlling the switching of the switches Sw1 and Sw2 may be the control signal of the preamplifier and correlated double sampling circuit 20, and the signals for controlling the switching of the switches Sw3 to Sw5 may be the control signal of the column ADC 31.

FIG. 8 illustrates an exemplary operation timing diagram. The operation timing diagram of FIG. 8 may represent the timing of the circuit of FIG. 7. In FIG. 8, the analog data is read from the imaging element circuit 110 (N read operation, S+N read operation), and the analog-digital conversion (ADC) is performed on the analog data.

The circuit of FIG. 7 may read the analog signal from the sub-pixel 11, for example, from the photodiode PD, based on one of the pixel control signals SLCT, RST, and TG according to the timing illustrated in FIG. 8. The correlated double sampling (CDS) processing is performed using the switching control signals to the switches Sw1 and Sw2, and the analog-digital conversion is performed using the switching control signals to the switches Sw3 to Sw5.

As illustrated in FIG. 8, when the switch Sw3 is turned off, the capacitor C3, coupled to a node n2, retains the signal. For example, the signals of eight lines from the sub-pixels are read in one horizontal time 1H, the analog-digital conversion is performed on the read signals in seven horizontal times 7H, and the signals are output.

Another configuration or operation of the circuit of FIG. 7 may be a configuration or an operation, for example, as disclosed in Japanese Laid-open Patent Publication No. 2006-21745.

The image sensor chip of FIG. 7 performs the CDS processing on the analog signal read from the pixel array 1 and analog-digital converts the CDS-processed signal to the analog signal.

For example, the CDS processing may be performed using the analog signal read from the pixel array 1 after the analog-digital conversion is performed.

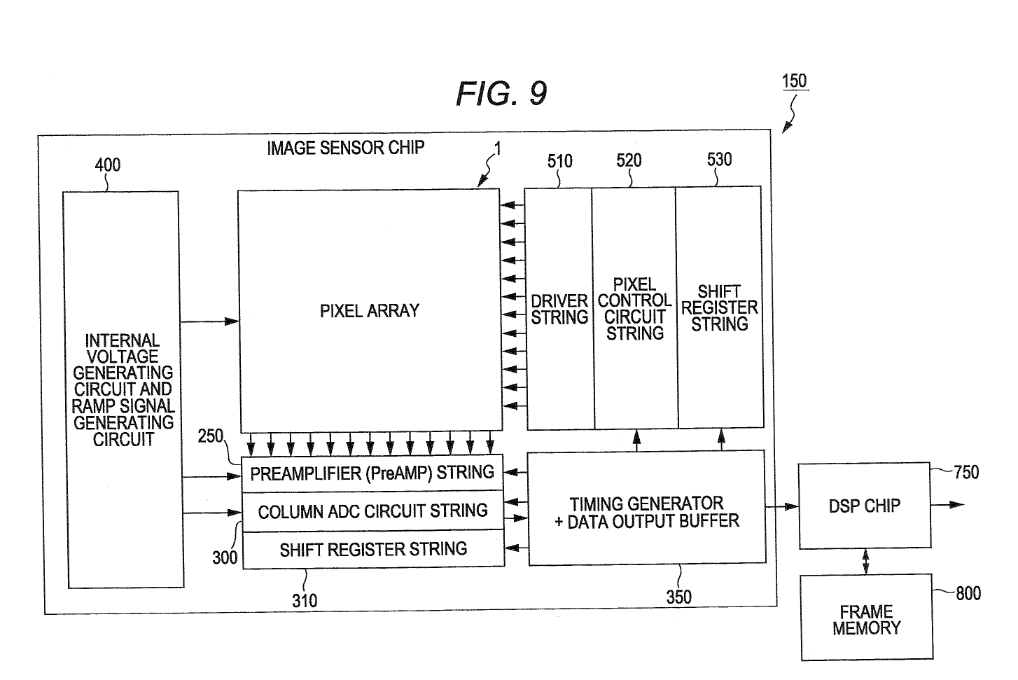

FIG. 9 illustrates an exemplary image sensor chip. In the image sensor chip of FIG. 9, the CDS processing is performed after the analog-digital conversion is performed.

In the image sensor chip 150 of FIG. 9, a preamplifier (Pre AMP) 250 amplifies the analog signal read from the pixel array 1, and the column ADC circuit string 300 performs the analog-digital conversion on the analog signal.

The digital data converted by the column ADC circuit string 300 may be supplied to a DSP chip 750 located outside the image sensor chip 150 through a timing generator and data output buffer 350.

For example, the DSP chip 750 may include the Image Signal Processor (ISP). For example, the DSP chip 750 may write a noise level in a frame memory 800 to perform the correlated double sampling (CDS) processing. The DSP chip 750 and the frame memory 800 may include the correlated double sampling (CDS) circuit.

In FIG. 9, the DSP chip 750 and the frame memory 800, which includes the CDS circuit, may be provided outside the image sensor chip 150. The DSP chip 750 and the frame memory 800 may be provided inside the image sensor chip 150.

The CDS circuits 750 and 800 may be provided at an output side of the column ADC circuit string 300 that performs the analog-digital conversion on the analog signal read from the pixel array 1.

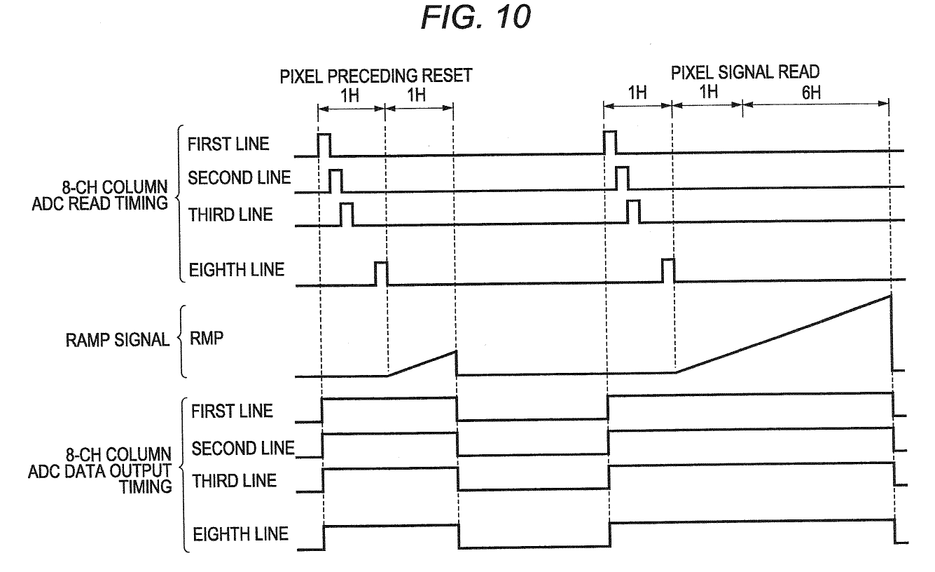

FIG. 10 illustrates an exemplary operation timing diagram. The operation timing diagram of FIG. 10 may represent the timing of the image sensor chip of FIG. 9. In FIG. 10, the pixel (sub-pixels) may be reset (pixel preceding reset). After the pixel is reset, the exposure operation may be performed, and the exposed signal may be read during the pixel signal read.

The noise level is read during the pixel preceding reset, and the column ADC string 300 performs the analog-digital conversion on the noise level data. The digital-converted data is written in the frame memory 800. Then the pixel signal is read, and the DSP chip 750 performs the correlated double sampling.

The CDS circuit may be provided in front of the column ADC, or may be provided at an output side of the column ADC.

Example embodiments of the present invention have now been described in accordance with the above advantages. It will be appreciated that these examples are merely illustrative of the invention. Many variations and modifications will be apparent to those skilled in the art.

1. An imaging device comprising:
a pixel array that includes a plurality of pixels;
a data read circuit configured to sequentially read the data of a given line from the pixel array;
a plurality of column analog-digital converters configured to perform analog-digital conversion on the data from the data read circuit; and
a control signal generating circuit configured to generate a control signal to control the analog-digital conversion.

2. The imaging device according to claim 1, wherein the data read circuit is configured to read data of a plurality of lines from the pixel array in a first period, and to supply the data to the corresponding plurality of column analog-digital converters, and
wherein the plurality of column analog-digital converters contemporaneously perform the analog-digital conversion on the data of the plurality of lines from the data read circuit in a second period.

3. The imaging device according to claim 2, wherein the second period is longer than the first period.

4. The imaging device according to claim 1, wherein a number of column analog-digital converters is substantially identical to a number of lines of the data read in the first period.

5. The imaging device according to claim 2, wherein a total of the first period and the second period corresponds to a time period that is allocated to reading the data of the plurality of lines and analog-digital converting.

6. The imaging device according to claim 5, wherein the first period corresponds to a time period that is allocated to reading the data of the given line and analog-digital converting.

7. The imaging device according to claim 1, further comprising
a correlated double sampling circuit that is provided between the pixel array and the plurality of column analog-digital converters.

8. The imaging device according to claim 1, further comprising
a correlated double sampling circuit that is provided at an output side of the plurality of column ADCs.

9. The imaging device according to claim 1, wherein the plurality of column analog-digital converters are provided on one side of the pixel array.

10. The imaging device according to claim 1, wherein the plurality of column analog-digital converters includes:
a first group of column analog-digital converters that are provided on one side of the pixel array; and
a second group of column analog-digital converters that are provided on the other side of the pixel array.

11. The imaging device according to claim 10, wherein the first group of column analog-digital converters are configured to perform the analog-digital conversion on data of even-numbered lines of the pixel array, and
wherein the second group of column analog-digital converters are configured to perform the analog-digital conversion on data of odd-numbered lines of the pixel array.

12. The imaging device according to claim 11, wherein the pixel includes a two-by-two matrix of four sub-pixels,
wherein the sub-pixels include a first sub-pixel configured to detect a first color, a second sub-pixel configured to detect a second color, and a third sub-pixel configured to detect a third color,
wherein the first group of column analog-digital converters performs the analog-digital conversion on data from the first sub-pixel and the second sub-pixel, and
wherein the second group of column analog-digital converters performs the analog-digital conversion on data from the second sub-pixel and the third sub-pixel.

13. An image sensor chip comprising:
an imaging element including a pixel array, the pixel array having a plurality of pixels;
a driver circuit configured to select a line of the pixel array;
an internal-voltage generating circuit that configured to generate an internal voltage to be supplied to a data read circuit, a plurality of column analog-digital converters, a control signal generating circuit, and the driver circuit; and
a timing generator that configured to generate a timing signal to be supplied to the data read circuit, the plurality of column analog-digital converters, the control signal generating circuit, and the driver circuit,
wherein the imaging element includes:
a data read circuit configured to sequentially read the data of a given line from the pixel array;
a plurality of column analog-digital converters configured to perform analog-digital conversion on the data from the data read circuit; and
a control signal generating circuit configured to generate a control signal to control the analog-digital conversion.

14. The image sensor chip according to claim 13,wherein the data read circuit is configured to read data of a plurality of lines from the pixel array in a first period, and to supply the data to the corresponding plurality of column analog-digital converters, and
wherein the plurality of column analog-digital converters are configured to contemporaneously perform the analog-digital conversion on the data of the plurality of lines from the data read circuit in a second period.

15. The image sensor chip according to claim 14, wherein the second period is longer than the first period.
